(19) United States
(12) Patent Application Publication
(10) Pub. No.: US 2005/0228518 A1
(43) Pub. Date: Oct. 13, 2005

(54) FILTER SET FOR FREQUENCY ANALYSIS

(75) Inventor: Lloyd Watts, Mountain View, CA (US)

Correspondence Address: CARR & FERRELL LLP, 2200 GENG ROAD, PALO ALTO, CA, 94303, US

(73) Assignee: Applied Neurosystems Corporation

(21) Appl. No.: 10/074,991

(22) Filed: Feb. 13, 2002

(51) Int. Cl. G06F 17/00

(52) U.S. Cl. 700/94; 381/98

(57) ABSTRACT

A system and method are disclosed for analyzing an input signal into a plurality of frequency components. In one embodiment, the input signal is processed with a first set of low pass filters to derive a first set of frequency components wherein the first set of low pass filters are arranged serially in a chain having a first low pass filter and a last low pass filter, the output of each low pass filter being fed to the next low pass filter in the chain until the last low pass filter. The output of the last low pass filter is downsampled to produce a downsampled signal. The downsampled signal is processed with a second set of low pass filters to derive a second set of frequency components.

### CROSS REFERENCE TO RELATED APPLICATIONS

This application claims priority to co-pending U.S. patent application Ser. No. 09/534,682 (Attorney Docket No. ANSCP001) entitled EFFICIENT COMPUTATION OF LOG-FREQUENCY-SCALE DIGITAL FILTER CASCADE filed Mar. 24, 2000, which is incorporated herein by reference for all purposes.

### FIELD OF THE INVENTION

The present invention relates generally to signal processing. A system and method for analyzing a signal into frequency components is disclosed.

### BACKGROUND OF THE INVENTION

A useful step in analyzing a signal is the separation of the signal into frequency components. For some time, the fast Fourier transform or FFT algorithm has been used to analyze a time domain signal into its frequency components. For various types of processing, and in particular for processing audio signals, it would be desirable to analyze a signal into its frequency components with improved temporal resolution at high frequencies and better spectral resolution at low frequencies. Numerous techniques have been proposed for accomplishing this. Included among such techniques are systems that use a set of filters to separate the signal being analyzed into different channels or frequency components. Such filter sets operate roughly in a manner that is analogous to a biological cochlea, which includes a series of filtered output signals that correspond to different frequency channels.

Filter sets may be implemented with analog or digital filters. Previous instantiations of filter sets have been limited by practical considerations in designing filters. For example, high order bandpass filters to separate each channel output are expensive to implement. Various approaches have been implemented using combinations of high pass and low pass filters; however, more efficient techniques are needed to allow real time processing of signals for various important applications including speech recognition, source separation of audio signals and stream separation of audio signals.

### BRIEF DESCRIPTION OF THE DRAWINGS

The present invention will be readily understood by the following detailed description in conjunction with the accompanying drawings, wherein like reference numerals designate like structural elements, and in which:

FIG. 1 is a block diagram illustrating a filter network used in one embodiment for analyzing an input signal into a plurality of frequency components.

FIG. 2 is a diagram illustrating an alternative embodiment wherein the low pass filters are not chained together at their inputs and outputs.

FIG. 3 is a signal flow graph of a filter equation.

FIG. 4 is a block diagram illustrating the arrangement of the filters.

FIG. 5 is a diagram illustrating an example of the filter response of a second-order section with poles only.

FIG. 6 is a diagram illustrating a typical filter response where Qₚ is the Q of the pole, Q_{z} is the Q of the zero, f_{cp} is the center frequency of the pole (also referred to as fₚ), and f_{cz} is the center frequency of the zero (also referred to as f_{z}).

FIG. 7 is a diagram illustrating filter responses for filters designed according to the critical band.

FIG. 8 is a diagram illustrating the phase characteristics for filters designed according to the critical band.

FIG. 9A is a diagram illustrating how a filter set as described herein is used in a voice recognition system.

FIG. 9B is a diagram illustrating how a filter set as described herein is used in an audio stream separation system.

FIG. 9C is a diagram illustrating how a filter set as described herein is used in a spatial correlator or sound localization system.

### DETAILED DESCRIPTION

A detailed description of a preferred embodiment of the invention is provided below. While the invention is described in conjunction with that preferred embodiment, it should be understood that the invention is not limited to any one embodiment. On the contrary, the scope of the invention is limited only by the appended claims and the invention encompasses numerous alternatives, modifications and equivalents. For the purpose of example, numerous specific details are set forth in the following description in order to provide a thorough understanding of the present invention. The present invention may be practiced according to the claims without some or all of these specific details. For the purpose of clarity, technical material that is known in the technical fields related to the invention has not been described in detail so that the present invention is not unnecessarily obscured.

A filter cascade for frequency analysis is disclosed that includes a number of features. In various embodiments, the features are implemented either separately or together. For example, in some embodiments, each frequency component is computed by subtracting the output of a low pass filter from the input to the filter. In this manner a bandpass signal is derived. In some embodiments, low pass filters are chained or cascaded with each filter output being fed to the next filter input in a filter set. The output of the last filter in the set is downsampled, with the filter set itself collectively acting as a high order antialiasing filter. The downsampled filter set output comprised of lower frequency components may then be more efficiently processed. Filters in the cascade may be designed so that the Q of the filters varies with frequency.

U.S. patent application Ser. No. 09/534,682 which was previously incorporated by reference (hereinafter, “the 682 application”) discloses a digital filter cascade for frequency analysis. The filters in the cascade are chained together and sets of filters are separated into octaves with downsampling between octaves. Filter parameters are shared among corresponding filters in different octaves. As described herein, advantages may be realized if filter parameters are varied among octaves in a manner that varies the Q, or sharpness of the filters among octaves. In one embodiment, the Q is varied substantially according to critical bandwidth.

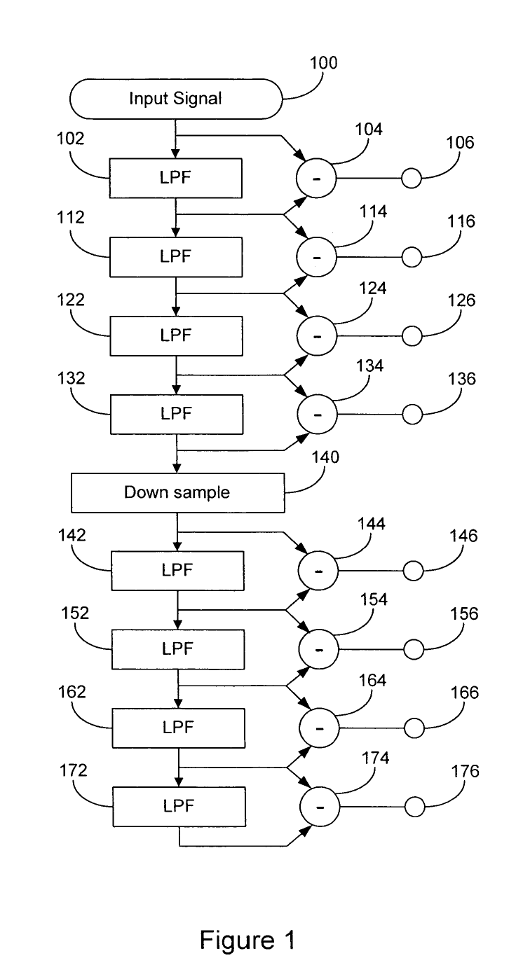

FIG. 1 is a block diagram illustrating a filter network used in one embodiment for analyzing an input signal into a plurality of frequency components. An input signal 100 is fed to a low pass filter (LPF) 102. The output of LPF 102 is subtracted from input signal 100 by a subtractor 104. The output at node 106 thus represents the difference between the signal before and after LPF 102. It emphasizes a band or channel of frequencies above the cutoff frequency of LPF 102 and whatever the upper frequency cutoff of the input signal happens to be. The output of LPF 102 is similarly directed to the input of LPF 112 and the difference between the input and the output of LFP 112 is computed by a subtractor 114 and output at node 116. The output at node 116 represents another frequency channel that emphasizes frequencies between the cutoff frequencies of LPF 102 and LPF 112. In a similar manner, LPF 122 and LPF 132 and subtractor 124 and 134 output other frequency channels at nodes 126 and 136. The output of the nodes may be further processed as is appropriate. For example, in some embodiments, the outputs are half wave rectified and in some embodiments, the gain of the outputs is adjusted to compress or expand the dynamic range.

In different embodiments, second order or higher digital or analog filters may be used. The nature of the filters, of course determines the exact nature of each channel output that generally emphasizes a given frequency band and thus has a general bandpass character. Collectively, the channel outputs represent the frequency components of the signal. Because of the subtraction of each LPF input and output, each channel output represents a band or slice of frequencies and the sum of all the outputs represents the entire input signal.

Because the output of each LPF is fed to the input of the next LPF, forming a chain of low pass filters, the output of the last LPF in the chain has characteristics of a much higher order filter than the order of the last filter. This higher order filtering effect may be exploited when the output of the last filter in the chain is downsampled. Essentially, the chain of low pass filters used to separate out frequency channels collectively act as a high order filter that performs the function of an anti aliasing filter when the signal is downsampled.

An example of this is depicted in FIG. 1 where downsampler 140 downsamples the output from LPF 132. It should be noted that only four filters are shown in the chain for the purpose of illustration. In most embodiments, more than four filters would be used to process a frequency range before downsampling. The downsampled signal output from downsampler 140 is then processed by another chain of low pass filters that includes LPF 142, LPF 142, LPF 142, LPF 142 and frequency channel outputs are derived by subtractors 144, 154, 164 and 174 at nodes 146, 156, 166 and 176.

In one embodiment, second order individual filters are used and a chain of 60 filters process one octave of the signal before downsampling. Downsampling may be implemented by simply discarding every other sample or any other appropriate technique.

The amount of downsampling is determined by the Nyquist criterion. A suitable amount of oversampling may be done as desired. The combined effect of the chain of filters is that of a very high order anti aliasing filter. Thus, downsampling the signal may be done to speed the processing of lower frequency octaves without requiring an expensive high order anti aliasing filter.

It should be noted that the benefit of chaining the low pass filters is realized in certain embodiments without implementing the subtractors to calculate the frequency bands. The output of each low pass filter may be used directly to represent the energy in each frequency channel. The output of the last filter in each chain is downsampled with the filter chain itself performing the finction of an antialiasing filter.

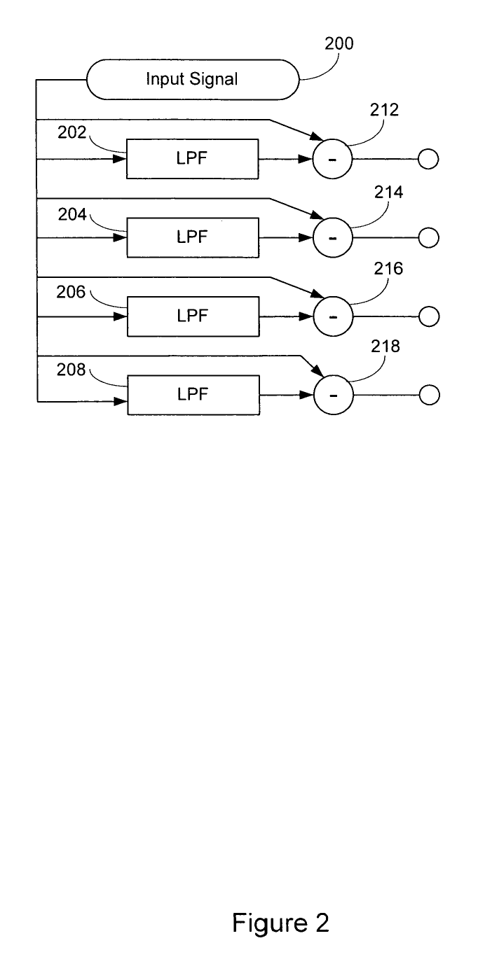

FIG. 2 is a diagram illustrating an alternative embodiment wherein the low pass filters are not chained together at their inputs and outputs. Input signal 200 is fed into low pass filters 202, 204, 206, and 208. The difference between the input and the output of each low pass filter is calculated by subtractors 212, 214, 216 and 218. Again, the differences calculated represent an analysis of the frequency bands or channels of the input signal. However, because the output of each filter is not fed to the input of the next filter, the higher order filter effect in the output of the last filter in the chain described above is not realized.

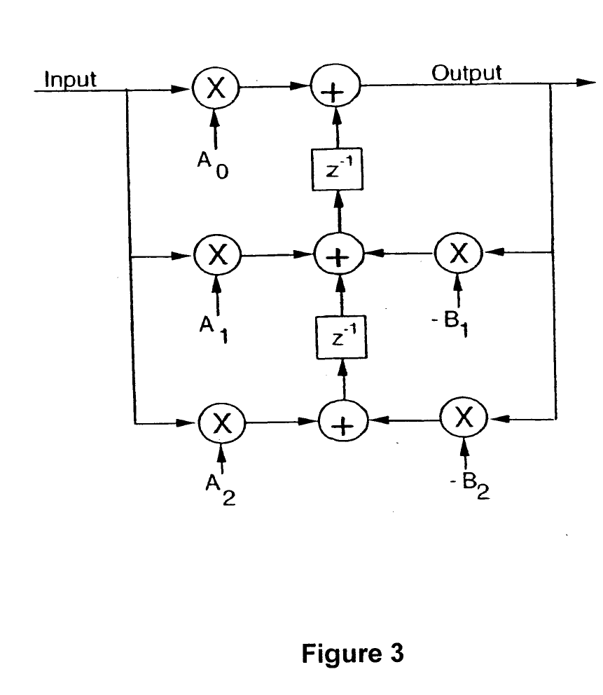

The filter cascade may be implemented using either analog or digital filters. In one embodiment, the filters are implemented as digital filters with cutoff frequencies designed to produce the desired channel resolution. Each filter has a set of coefficients (a₀, a₁, a₂, b₁, b₂) associated with it. The output of each filter is calculated according to the following function:
yₙ=a₀xₙ+a₁xₙ₋₁+a₂xₙ₋₂−b₁yₙ₋₂yₙ₋₂ Equation 1.
where the filter output yₙ is a function of the input data xₙ at time n, previous inputs xₙ₋₁ and xₙ₋₂, and previous outputs yₙ₋₁ and yₙ₋₂. FIG. 3 is a block diagram illustrating this signal flow. The output of the filter yₙ is passed to the input xₙ of the next filter in the cascade.

The filter response H(z) is given by the following:

$$H ( z ) = \frac{{a}_{0} + {a}_{1} {z}^{- 1} + {a}_{2} {z}^{- 2}}{1 + {b}_{1} {z}^{- 1} + {b}_{2} {z}^{- 2}} . \qquad Equation 2$$

and z=e^{1*(ω/ωs)}, ω=2πf, ωₛ=2πf, where fₛ is the sampling frequency.

Substitution of the above into the transfer function of Equation 2 produces a filter response H(f), which is a function of the filter coefficients a₀, a₁, a₂, b₁, b₂ and the sampling rate fₛ.

As described in the 682 application, the filter coefficients may be reused between sets of filters with the response of the filters being altered as a result of downsampling between the sets of filters. In the embodiment shown, the filters are evenly distributed over the octaves, resulting in 60 filters per octave. 60 objects are created in a computer. Each object has a set of coefficients as described above, and additionally has ten sets of state variables, corresponding to ten filters running at frequencies that are whole octaves apart. The 60 objects using their first sets of state variables correspond to the first octave group of filters, while the 60 objects using their second sets of state variables (and sampling at a lower frequency) correspond to the second octave group of filters, and so on. In another embodiment, each object contains a set of coefficients, but only one set of state variables, and is run at a single frequency. In this case, 600 objects are required to represent 600 filters.

The filters in the first octave are tuned to the frequencies in the highest octave, 20 kHz to 10 kHz, and are sampled at 44.1 kHz, which satisfies the Nyquist sampling criterion. The filters in the second octave are tuned to half of the frequencies of the corresponding filters in the first octave, and range from 10 kHz to 5 kHz. These filters in the second octave are sampled at 22.05 kHz, half of the first sampling frequency. Coefficients for each filter are stored in memory and applied in the computations for the filters. The cascade response is the sum of responses of individual filters (which are all weak responses by themselves, but when summed, produce a much stronger response). The coefficients of the filters are determined by the desired response.

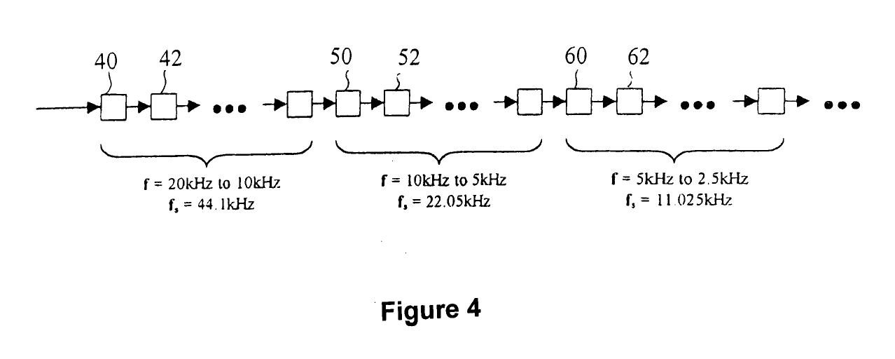

As the audio signal is passed through each filter, the signal is sampled and filtered before being passed to the next filter. FIG. 4 is a block diagram illustrating the arrangement of the filters. At the end of the first octave, the signal is passed into the first filter in the next octave, which comprises filters sampling at half the sampling rate of the first octave, as stated above. Successive octaves are downsampled in a similar manner, using the same factor of two. In this configuration, each stage acts as an anti-aliasing filter for later stages, removing the high frequencies sufficiently to allow downsampling without aliasing. No extra anti-aliasing filters are required.

Downsampling each successive octave significantly decreases the computational complexity of the system. In addition, the required precision for filter coefficients is lower, and thus, fewer bits are required to represent each coefficient. Digital low-pass filters have the property that the numerical precision required to represent the filter coefficients depends on the ratio between the cutoff frequency and the sampling frequency. For a given sampling frequency, a filter with a low cutoff frequency will require higher-precision coefficients than a filter with a higher cutoff frequency. Without the successive downsampling technique, very high-precision filter coefficients (on the order of 23 bits) are required to represent the lowest-cutoff-frequency filters (30 Hz) at the 44 kHz sampling rate. With the successive downsampling technique, lower-precision coefficients (on the order of 12 bits) can be used to represent the 30-Hz cutoff filters, since the sampling rate is much lower in the lowest octave after many downsampling steps. This reduced precision results in lower hardware complexity (less memory, smaller registers, lower-precision arithmetic operators) and thus lower overall cost in a custom hardware implementation.

In the embodiment described in the 682 application, each filter shares filter parameters with filters that are one, two, or more octaves higher or lower, resulting in reduced storage requirements. For example, the highest frequency filter 40 in the first octave shares filter coefficients with the highest frequency filter 50 in the second octave, the highest frequency filter 60 in the third octave, and so on. The second-highest frequency filter 42 in the first octave shares filter coefficients with the second-highest frequency filters 52 and 62 in the second and third octaves, and with all other corresponding filters (tuned to frequencies that are one, two, or more octaves lower).

Alternatively, it has been determined that the delay at low frequencies can be improved by changing the filter parameters within each octave as described below. For many systems, this is preferable to sharing filter parameters between corresponding filters in different octaves because the benefit from improved delay at low frequencies offsets increased memory storage requirements.

In one embodiment, filter coefficients are tuned to produce a desired Q (quality factor, or degree of sharpness or frequency selectivity) depending on the frequency band (determined by the frequency cutoff) being processed by the filter. Reusing filter coefficients in the cascade results in a cascade with constant Q, and all the filter responses will have the same shape (Q). This “constant-Q” configuration has the advantages of conceptual simplicity and shared filter coefficients, but has significant delays at low frequencies. For example, for a constant-Q design with a phase accumulation of four cycles at all frequencies, the delay at the 20 kHz tap will be 200 μs, while the delay at the 20 Hz tap will be 200 ms. Faster performance at low frequencies is desirable to improve the response time of the cascade, which may be accomplished by changing the filter coefficients of the filters in lower octaves.

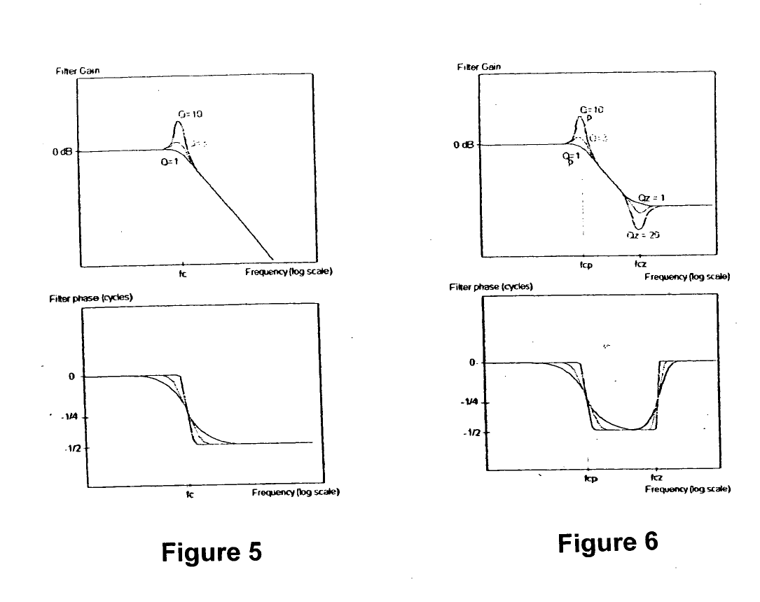

FIG. 5 is a diagram illustrating an example of the filter response of a second-order section with poles only. The filter may be described in terms of the time constant Tau and quality factor Q, or in terms of filter coefficients b₁ and b₂ mentioned previously. Tau is the inverse of the center frequency f_{c} and describes where the peak is, while Q describes how sharp the peak is. As can be seen from FIG. 5, a higher Q results in a sharper peak, while f_{c} indicates where the peak occurs. The equations for the filter are as follows:

$$\begin{matrix}Vout ( z ) = \frac{1}{1 - {b}_{1} {z}^{- 1} - {b}_{2} {z}^{- 2}} Vin ( z ) \\ and \\ Vout ( s ) = \frac{1}{1 - Tau s \text{/} Q + {Tau}^{2} {s}^{2}} Vin ( s )\end{matrix}$$

where the relationship between Tau, Q and b₁, b₂ are given in the “Lyon's Cochlear Model” Apple Technical Report #13 by Malcolm Slaney © 1988 which is herein incorporated by reference. The filter coefficients for the filter can be determined from the center frequency f_{c}=1/Tau, and the Q of the filter.

The filters may be designed to have zeros as well as poles, and the equation for such a system is given by

$$Vout ( s ) = \frac{1 + {Tau}_{z} s \text{/} {Q}_{z} + {Tau}_{z}^{2} {s}^{2}}{1 + {Tau}_{p} s \text{/} {Q}_{p} + {Tau}_{p}^{2} {s}^{2}} * Vin ( s )$$

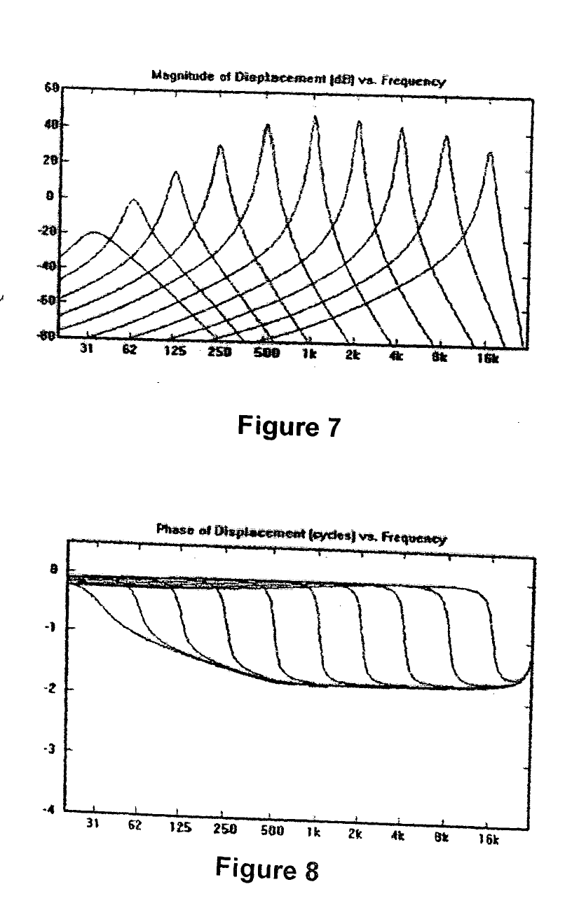

FIG. 6 is a diagram illustrating a typical filter response where Qₚ is the Q of the pole, Q_{z} is the Q of the zero, f_{cp} is the center frequency of the pole (also referred to as fₚ), and f_{cz} is the center frequency of the zero (also referred to as f_{z}). The zeros arrest the dropping gain, and reverse the phase back up to zero. The closer the zero is to the pole, the sooner these effects occur. If the zero is very close to the pole, the phase trajectory may not get very far (a small fraction of a cycle) before the zero reverses it. This property is the key to controlling the total amount of phase accumulation through the cascade, and hence the delay response of the cascade.

If 600 filters are used, and implemented with a cascade of 600 poles-only sections, each one would contribute a quarter-cycle of phase accumulation at its best frequency, resulting in a large amount of delay. In one embodiment, the filter cascade is configured so that the center frequencies decrease exponentially through the cascade. The Q's decrease gradually through the cascade, to give sharp responses at high frequencies, where delay is not an issue, and to give fast responses at low frequencies, where some loss of sharpness is acceptable in return for faster response. This implementation of nonconstant Q filters is particularly useful for signal processing systems used, for example in submarine passive sonar, speech recognition, music transcription, audio stream separation and sound localization. It should be noted that this approach is not limited to downsampled filter cascades, and may be used with filter cascades with no downsampling.

Design of a filter cascade with constant-Q involves choosing the range of cutoff frequencies and the number of taps per octave, such as a frequency range of 20 Hz to 20 kHz, 600 taps, 10 octaves (60 taps/octave). This determines fₚ for each tap. Fixed values are chosen for Qₚ, Q_{z}, and fᵣₐₜᵢₒ=f_{z}/fₚ, based on the sharpness and delay desired through the cascade. In one embodiment, values used for a constant-Q design may be Qₚ=7.0, Q_{z}=7.5, and fᵣₐₜᵢₒ=1.03. In another embodiment, the values may be Qₚ=23, Q_{z}=26, and fᵣₐₜᵢₒ=1.01.

For a variable-Q filter cascade using 600 taps in 10 octaves, one embodiment may employ the following values: Qₚ=7.0, Q_{z}=7.0, and fᵣₐₜᵢₒ=1.03, with a sampling rate of 44.1 kHz and 2× oversampling in the highest octave. These values are used for the first 360 taps, and then varied linearly over the next 240 taps to Qₚ=1.6, Q_{z}=1.6, and fᵣₐₜᵢₒ=1.1 at tap 600 (the lowest frequency tap). This results in a design with broader filter responses at low frequencies, but much faster time response.

In another embodiment, the Qₚ, Q_{z}, and fᵣₐₜᵢₒ parameters are selected to match the filter responses to appropriate psychophysical critical bandwidth and loudness perception curves. Critical bandwidth is the tuning width of the filter response curves, within which signal components can interact with each other. Critical bandwidth curves are given in Rossing, 1982, “The Science of Sound” (Addison-Wesley, Reading, Mass.), the disclosure of which is hereby incorporated by reference. The critical bandwidth varies from a little less than 100 Hz at low frequencies to between two and three musical semitones (12% to 19%) at high frequencies. Loudness perception describes how sensitive the filters are to different frequencies. For example, the threshold of audibility at 20 Hz is about 65 dB higher than at 1 kHz.

One embodiment of a variable-Q filter cascade uses the following parameters:
Tap 0: Qₚ=7.0, Q_{z}=7.0, fᵣₐₜᵢₒ=1.03
Tap 300: Qₚ=11.0, Q_{z}=11.0, fᵣₐₜᵢₒ=1.03
Tap 360: Qₚ=9.0, Q_{z}=11.0, fᵣₐₜᵢₒ=1.03
Tap 600: Qₚ=1.6, Q_{z}=1.6, fᵣₐₜᵢₒ=1.01

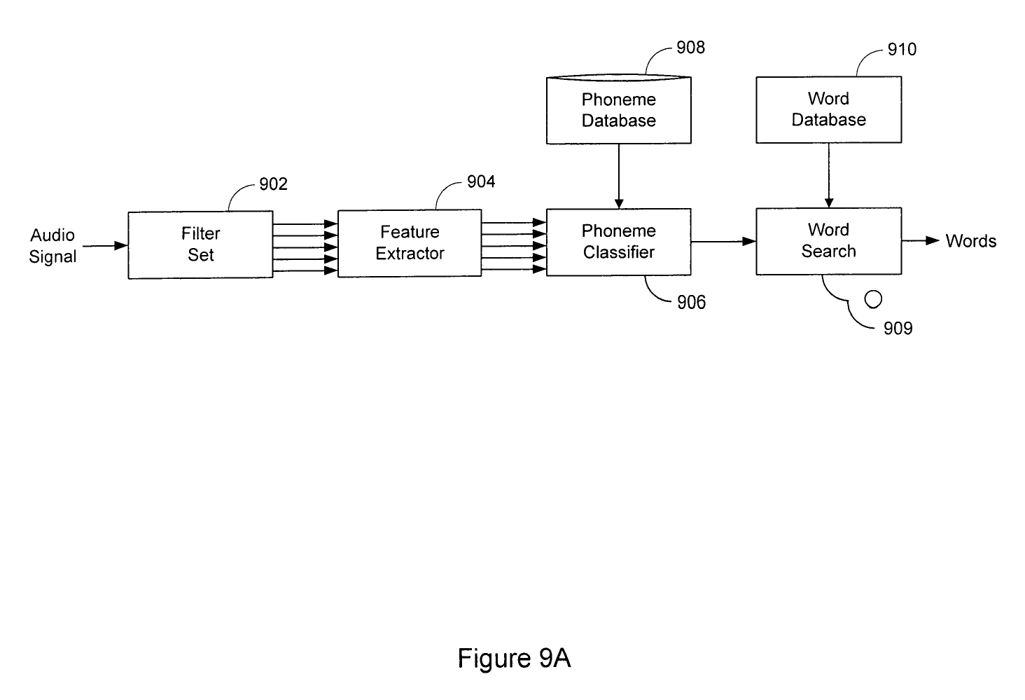

with linear interpolation of parameters between the specified taps. This piecewise linear variation of the parameters gives a good fit to the psychophysical critical bandwidth and loudness perception curves. FIG. 7 is a diagram illustrating filter responses for filters designed according to the critical band. The filter responses are sharp at mid-range frequencies, and very broad at low frequencies, corresponding to the critical bandwidth curve. The filters are more sensitive at mid-range frequencies, and about 65 dB less sensitive at low frequencies, so as to match the loudness perception parameters.

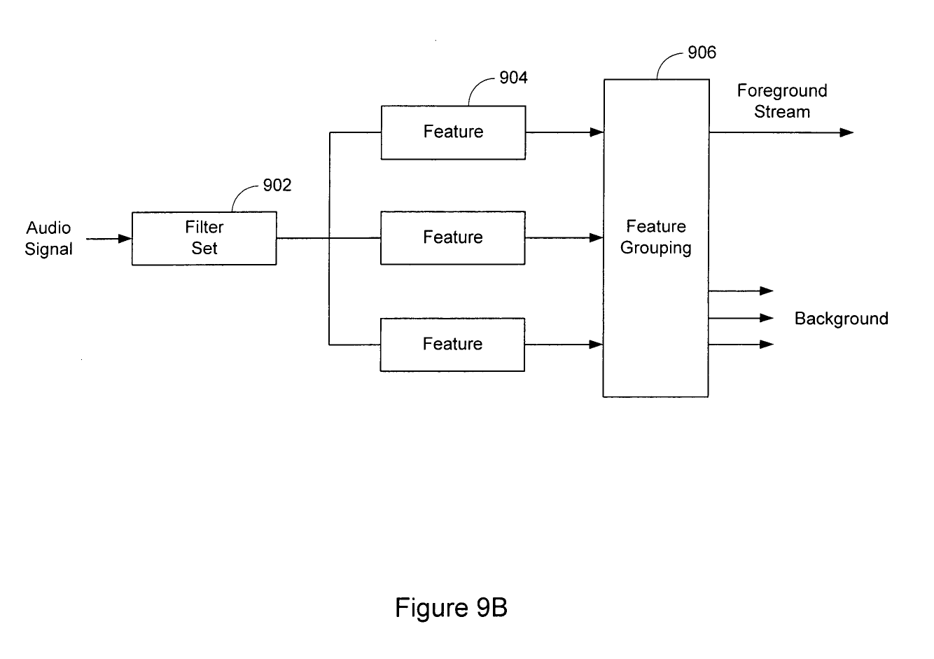

FIG. 8 is a diagram illustrating the phase characteristics for filters designed according to the critical band. The phase characteristics of the filters are such that there are about two cycles of phase accumulation at mid-to-high frequencies, but much less at low frequencies. This results in a faster response at low frequencies, where it is needed.

A filter cascade for analyzing a signal into frequency components has been described. In various embodiments, the filter cascade utilizes different techniques to improve temporal resolution at high frequencies and spectral resolution at low frequencies. As a result, each of the disclosed filter cascade embodiments are particularly useful as a component of a voice recognition system. In addition, the filter cascade is useful for audio stream separation and sound localization.

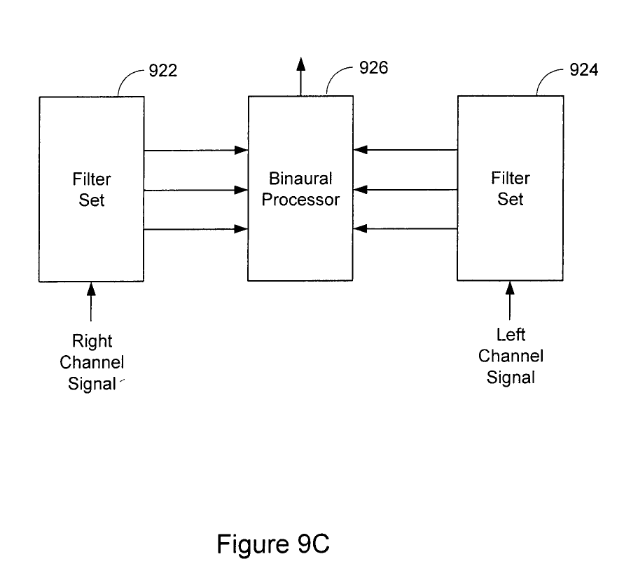

FIG. 9A is a diagram illustrating how a filter set as described herein is used in a voice recognition system. An audio signal is input to a filter set 902 and the output of the filter set is analyzed by a feature extractor 904. The features are classified by a phoneme classifier 906 that matches features with phonemes included in a phoneme database 908. Words are derived based on the phonemes by a word search block 909 that access a word database 910.

FIG. 9B is a diagram illustrating how a filter set as described herein is used in an audio stream separation system such as is described in U.S. Patent Application No. 60/300,012 (Attorney Docket No. ANSCP003+) by Lloyd Watts (filed Jun. 21, 2001,) entitled: ROBUST HEARING SYSTEMS FOR INTELLIGENT MACHINES which is herein incorporated by reference. An audio signal is input to a filter set 912 and the output of the filter set is analyzed by a set of feature extractors 914 that extract features. The features are grouped by feature grouping processor 916 into separate streams of associated audio signals.

FIG. 9C is a diagram illustrating how a filter set as described herein is used in a spatial correlator or sound localization system such as is described in U.S. patent application Ser. No. 10/004,141 (Attorney Docket No. ANSCP005) by Lloyd Watts (filed Nov. 14,2001) entitled: COMPUTATION OF MULTI-SENSOR TIME DELAYS which is herein incorporated by reference. A right channel audio signal is input to a right channel filter set 922 and a left channel audio signal is input to a left channel filter set 924. The outputs of the filter sets are correlated by a binaural processor 926 to determine the time delay between the left and right channel input signals. The direction from which a sound emanates may be determined from the time delay.

Although the foregoing invention has been described in some detail for purposes of clarity of understanding, it will be apparent that certain changes and modifications may be practiced within the scope of the appended claims. It should be noted that there are many alternative ways of implementing both the process and apparatus of the present invention. Accordingly, the present embodiments are to be considered as illustrative and not restrictive, and the invention is not to be limited to the details given herein, but may be modified within the scope and equivalents of the appended claims.

1. A method of analyzing an input signal into a plurality of frequency components comprising:
processing the signal with a first set of low pass filters to derive a first set of frequency components wherein the first set of low pass filters are arranged serially in a chain having a first low pass filter and a last low pass filter, the output of each low pass filter being fed to the next low pass filter in the chain until the last low pass filter;
downsampling the output of the last low pass filter to produce a downsampled signal;
processing the downsampled signal with a second set of low pass filters to derive a second set of frequency components.

2. A method of analyzing an input signal into a plurality of frequency components as recited in claim 1 wherein the frequency components are derived by subtracting the output of each low pass filter from the input to the low pass filter.

3. A method of analyzing an input signal into a plurality of frequency components as recited in claim 1 wherein the second set of low pass filters have a different Q than the first set of low pass filters.

4. A method of analyzing an input signal into a plurality of frequency components as recited in claim 1 wherein the second set of low pass filters have a Q that is less sharp than the first set of low pass filters.

5. A method of analyzing an input signal into a plurality of frequency components as recited in claim 1 wherein the second set of low pass filters have a Q that differs from the Q of the first set of low pass filters substantially according to human critical bandwidth.

6. A method of analyzing an input signal into a plurality of frequency components comprising:
processing the signal with a first low pass filter to produce a first low pass filtered signal;
subtracting the first low pass filtered signal from the input signal to derive a first frequency component;
processing the signal with a second low pass filter to produce a second low pass filtered signal; and
subtracting the second low pass filtered signal from the first low pass filtered signal to derive a second frequency component.

7. A method of analyzing an input signal into a plurality of frequency components comprising:
processing the signal with a first low pass filter to produce a first low pass filtered signal;
subtracting the first low pass filtered signal from the input signal to derive a first frequency component;
processing the low pass filtered signal with a second low pass filter to produce a second low pass filtered signal; and
subtracting the second low pass filtered signal from the first low pass filtered signal to derive a second frequency component.

8. A method of analyzing an input signal into a plurality of frequency components comprising:
processing the signal with a first filter wherein the first filter is configured to separate part of the signal into a first output frequency channel; and
processing the signal with a second filter wherein the second filter is configured to separate part of the signal into a second output frequency channel wherein the first frequency channel emphasizes higher frequencies than the second frequency channel; and
wherein the second filter has a different Q than the first filter.

9. A method of analyzing an input signal into a plurality of frequency components as recited in claim 8 wherein the second filter has a Q that is less sharp than the first filter.

10. A method of analyzing an input signal into a plurality of frequency components as recited in claim 8 wherein the second filter has a Q that differs from the Q of the first filter substantially according to human critical bandwidth.

11. A method of analyzing an input signal into a plurality of frequency components as recited in claim 8 wherein the filters are low pass filters.

12. A system for analyzing an input signal into a plurality of frequency components comprising:
a first set of low pass filters configured to derive a first set of frequency components wherein the first set of low pass filters are arranged serially in a chain having a first low pass filter and a last low pass filter, the output of each low pass filter being fed to the next low pass filter in the chain until the last low pass filter;
a downsampler configured to downsample the output of the last low pass filter to produce a downsampled signal;
a second set of low pass filters configured to process the downsampled signal to derive a second set of frequency components.

13. A system for analyzing an input signal into a plurality of frequency components as recited in claim 12 wherein the frequency components are derived by subtracting the output of each low pass filter from the input to the low pass filter.

14. A system for analyzing an input signal into a plurality of frequency components as recited in claim 12 wherein the second set of low pass filters have a different Q than the first set of low pass filters.

15. A system for analyzing an input signal into a plurality of frequency components as recited in claim 12 wherein the second set of low pass filters have a Q that is less sharp than the first set of low pass filters.

16. A system for analyzing an input signal into a plurality of frequency components as recited in claim 12 wherein the second set of low pass filters have a Q that differs from the Q of the first set of low pass filters substantially according to critical band.

17. A system for analyzing an input signal into a plurality of frequency components as recited in claim 12 wherein the system is used in a voice recognition system.

18. A system for analyzing an input signal into a plurality of frequency components as recited in claim 12 wherein the system is used for audio stream separation

19. A system for analyzing an input signal into a plurality of frequency components as recited in claim 12 wherein the system is used for sound localization.

20. A system for analyzing an input signal into a plurality of frequency components comprising:
a first low pass filter that outputs a first low pass filtered signal;
a first processor configured to subtract the first low pass filtered signal from the input signal to derive a first frequency component;
a second low pass filter that outputs a second low pass filtered signal; and
a second processor configured to subtract the second low pass filtered signal from the first low pass filtered signal to derive a second frequency component.

21. A system for analyzing an input signal into a plurality of frequency components comprising:
a first low pass filter that outputs a first low pass filtered signal;
a first processor configured to subtract the first low pass filtered signal from the input signal to derive a first frequency component;
a second low pass filter configured to process the low pass filtered signal to produce a second low pass filtered signal; and
a second processor configured to subtract the second low pass filtered signal from the first low pass filtered signal to derive a second frequency component.

22. A system for analyzing an input signal into a plurality of frequency components comprising:
a first filter configured to process the signal wherein the first filter is configured to separate part of the signal into a first output frequency channel; and
a second filter configured to process the signal wherein the second filter is configured to separate part of the signal into a second output frequency channel wherein the first frequency channel emphasizes higher frequencies than the second frequency channel; and wherein the second filter has a different Q than the first filter.

23. A system for analyzing an input signal into a plurality of frequency components as recited in claim 22 wherein the second filter has a Q that is less sharp than the first filter.

24. A system for analyzing an input signal into a plurality of frequency components as recited in claim 22 wherein the second filter has a Q that differs from the Q of the first filter substantially according to a critical band.

25. A system for analyzing an input signal into a plurality of frequency components as recited in claim 22 wherein the filters are low pass filters.
